(19) United States
(12) Patent Application Publication
(10) Pub. No.: US 2002/0180726 A1
(43) Pub. Date: Dec. 5, 2002

(54) Paper-based remote sketching system

(76) Inventors: Jianbo Shi, Pittsburgh, PA (US); Simon Baker, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 09/682,999

(22) Filed: Nov. 6, 2001

Related U.S. Application Data
(60) Provisional application No. 60/246,173, filed on Nov. 6, 2000.

(51) Int. Cl. G06T 1/00

(52) U.S. Cl. 345/418

(57) ABSTRACT

A system allowing the real-time remote transmission of hand-drawn sketches drawn with conventional means (i.e., a pen or pencil and a piece of paper) is disclosed. The system tracks updates drawn on the paper and transmits them to remote sites. Updates may also be made at remote sites and viewed locally. Also provided are means for archiving and re-playing sequences of updates to a document. Significantly, the system has the ability to track any movements of the paper and to dynamically adjust the system to properly display the image correctly positioned on the paper at the remote sites.

### RELATED APPLICATIONS

### Referenced-applications

This application claims the benefit of U.S. provisional application serial No. 60/246,173, filed Nov. 6, 2000.

### FIELD OF THE INVENTION

This invention related to the field of remote conferencing, and, specifically, discloses a system whereby hard copy documents, or sketches on regular paper can be updated and viewed in real time at multiple sites. The system allows two people to interact as though they are both writing on the same piece of paper, for example, playing a paper game such as tic-tac-toe, whereas in reality they could be thousands of miles apart.

### BACKGROUND OF INVENTION

Hand-drawn sketches are an important means of communication between individuals or between an individual and a group of people. Many things are better described with a hand-drawn picture or sketch, rather than in words. Some examples include driving direction, educational lectures and changes to business documents.

When two or more people are in the same room, and one wants to draw a description or explanation, they typically pick up a pen and a piece of paper and draw a sketch. Alternatively, an overhead projector or whiteboard may be used. When the same people are remote from each other, for example, during a tele-conference or speaking over the phone, the option of simply using a pen and paper is not available. It would therefore be desirable to have a means of transmitting hand-drawn text or graphics in a real-time environment, utilizing the familiar pen and paper concept as the user interface.

Another advantage of having hard copy sketches is that the hard copy sketch can be passed around from person to person. Of course, this capability can be achieved through laptop/tablet PC, but this system be used by those unfamiliar with a computers as well as those who are computer literate.

Several devices known in the art attempt to provide a solution to this problem by combining LCD projectors and video cameras. For example, the UNC “Office of the Future” uses a projector/camera combination for “tele-collaboration.” The goal with this system is to get a better view of the workspace and people at the remote site. The people communicate with voice and “facial expression.” However, no provision is made for the transmission of hand-written text or graphics.

Several other uses of a projector/camera combination for human-computer interaction (HCl) are known in the art. With the majority, the goal is to provide an enhanced workspace, and to allow input via “pointing.” Most of the devices, such as the Augmented Desk, a project in Gifu, Japan, and a similar project at Stanford, are for HCl only, rather than as a communication device between people.

The devices known in the art which are closest to solving the cited problem are systems for reading information off a whiteboard and projecting it onto a remote whiteboard. One such system has been developed by just Research.

Another closely related system developed by P. Wellner is called DigitalDesk. In this system the desktop is enhanced using a digital projector and camera to provide a PC Window like interface to a computer. In this system, a paper document can be stored and transmitted to another remote site. However, in DigitalDesk, the paper is static, no dynamic interaction of the paper through sketching is permitted, and no dynamic movement of paper is allowed.

### SUMMARY OF INVENTION

Disclosed herein is a system that provides a solution which allows two (or more) people to communicate remotely via hand-drawn sketches or pictures on a regular piece of paper. In this system, a camera captures a person's pen marks as they are made on an ordinary piece of paper in is view. The video is transmitted to projector on the other side of the connection, which then projects the images onto the collaborator's paper. The people at the remote sites thereby get the impression that the sketch is being drawn locally. Additionally, people at the remote site can also participate in the sketch and add to the drawing. All of the users (including the first one) would then see these updates too.

To achieve natural interaction, the key features of the disclosed invention are 1) each person can write on their paper at the same time, 2) the papers can be placed anywhere on the desktop and moved around at will, and 3) the desktop around the paper can be arbitrarily cluttered by other objects. The disclosed invention is differentiated from the prior art in that the piece of paper may move and so must be tracked in real-time against all possible background clutter. This is accomplished by a precision algorithm that can digitally align and warp papers at remote sites in real-time.

One way to build a system to allow people to communicate using hand-drawn sketches would be to use touch-sensitive tablet displays or electronic pens. However, drawing on glass with a stylus is far less natural than with a pen or pencil on paper.

In addition to the advantage of providing a natural and useable interface, the disclosed invention also has the ability to allow the users to make changes to already-existing hard copy documents. Further, because the images are digitally stored, they can be archived, reprinted, and replayed thereby creating a digital copy of the interaction.

### BRIEF DESCRIPTION OF DRAWINGS

FIG. 1 is a schematic representation of the system of the invention.

FIG. 2 is a schematic representation of two or more of the systems of the invention connected by a communications network.

FIGS. 3(a-c) is a sequence of pictures showing the dynamic adjustment of the projected image as the paper moves.

FIG. 4(a) is a state diagram showing the two basic states of the system.

FIG. 4(b) is a diagram showing the capturing of various updates to the drawing.

FIG. 5 shows various examples of the image recognition capabilities of the invention.

FIG. 6 shows a second embodiment of the invention utilizing an adapter for an existing LCD projector

### DETAILED DESCRIPTION

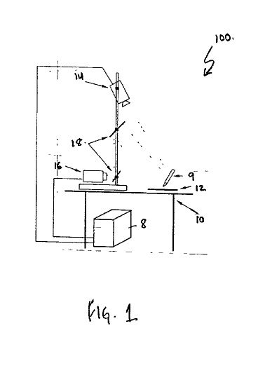

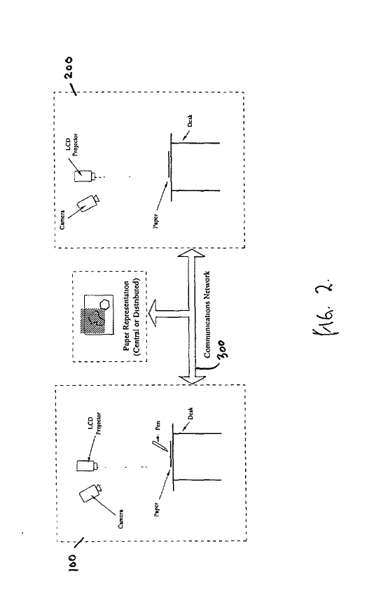

The disclosed invention comprises two or more instances of a system comprising a camera/projector pair, shown in FIG. 2 as 100 and 200, connected by communications network 300, such as the Internet or other interconnection means. As shown in FIG. 1, an intelligent desktop 100 comprises four major components:

regular sheet of paper 12, computer 8, video camera 14 and projector 16. Video camera 14 and projector 16 must be fixed relative to each other such that their fields of view substantially overlap. This can be accomplished by direct alignment, or alignment assisted by one or more mirrors 19. Paper 12 must be placed somewhere in this overlap region, but need not remain stationary during operation of the system, as long as it remains within the overlap region. Preferably projector 16 is an LCD projector, but any projector capable o projecting an image from a computer is acceptable.

The operation of the system is relatively straightforward. The hand-drawn sketch is captured from the piece of paper at one site using video camera 14 and projected onto piece of paper 12 at a remote site using LCD projector 16. At each site, a real-time algorithm is used to process the captured images of the workspace to automatically extract the paper location and orientation, against all possible background clutter. This is done by computing the four bounding edges of the paper, to determine the four paper corners, even though each corner can be occluded by hands or other objects. The images of paper are re-warped to its standard rectangular shape, and are stored on computer 8, at both the local and remote sites. The images of the paper are transmitted using computer network to the remote site at a rate of at least 30 frames per second. At the remote site, the images are re-warped to align perfectly with the paper as oriented in its workspace. The person at the remote site thereby gets the impression that the sketch is being drawn locally. Naturally, they too can interactively participate in the sketch, in which case what they draw is transmitted in the other direction and is projected onto the first person's paper.

The internal representation of what has been sketched on paper 12 is stored on computer 8 and is continuously projected on the paper at all of the sites. Because pieces of paper 12 can move, they must be tracked with video cameras 14. The location of paper 12 is then used by computers to warp the internal representation appropriately so that when displayed by projector 16, the image is correctly aligned with paper 12, wherever it is, and whatever its orientation.

It is necessary to track the position of paper 12 for two reasons. First, it is necessary to know where to project the image and in what orientation; and, second, it is necessary to know where to look to extract what has been drawn on paper 12.

Next, the internal representation on computer 8 of what has been drawn on the paper needs to be warped appropriately so that when displayed by LCD projector 16, it appears correctly on the page. This step can easily be performed using texture mapping hardware known in the art. The transformations between camera 14 and LCD projector 16 is calibrated in an offline preprocessing step. LCD Projector 16 displays a rectangle, the corners of which are located in an image captured by camera 14. The transformation between the two coordinate systems can thus easily be deduced.

To prevent visual “echoing” between the two sites, an image of paper 12 must be extracted when drawing stops to update the internal representation. This image should not include any of the information being projected onto it by LCD projector 16.

Time multiplexing can be used to obtain such an image, i.e., to extract such an image, the projector projects a single constant intensity image and video camera 14 is synchronized to capture a frame at precisely that moment.

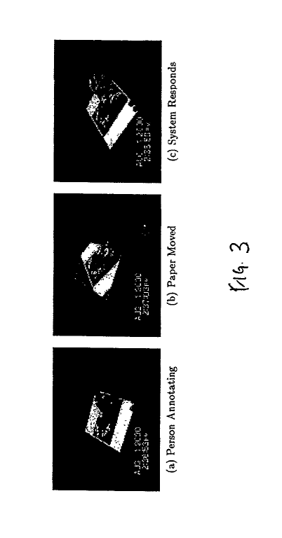

FIGS. 3(a-c) show the system in operation. In FIG. 3(a) the system is projecting a picture onto a blank sheet of paper 12. The person is annotating the picture, highlighting a particular point of interest to other users. In FIG. 3(b) the person decides to move paper 12 to get a better angle for writing. FIG. 3(c) shows that the system detects that paper 12 has moved and changes where it is projecting so that the picture is still aligned with the paper and, more importantly, what the person has drawn on it.

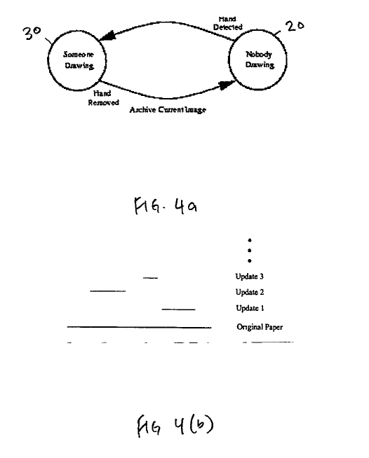

The invention also contemplates the archival and re-play of the edits made to a drawing. For a sketch to be efficiently archived and re-played, it must be broken down into a sequence of drawing operations. As shown in FIG. 4, for archival purposes, the system can be in one of two basic states: “drawing”, shown as 20 in FIG. 4, and “static”, shown as 30 in FIG. 4. The system enters the “drawing” state 30 when a hand is detected above one of the pieces of paper 12. The system returns to the “static” state 20 when the hand is removed. If computer 8 detects that more than one site is attempting to draw at about the same time, one of the sites is arbitrarily chosen and all other sites are ignored until the chosen site stops drawing. To implement this feature, it is necessary to be able to detect when a hand is above paper 12; when it appears and when it leaves. This step can be performed either using a color-based skin detection algorithm, or a (background subtraction) moving object detection algorithm, both of which are known in the art.

When the system transition from a “drawing” state 30 to a “static” state 20 as shown in FIG. 4(a), the internal representation of what is drawn on the paper is updated. A static image of the page is captured and added to the current representation, as illustrated in FIG. 4(b). Once the drawing has been broken down a into a sequence of discrete updates, we can store each update efficiently together with any meta-data, such as when the update occurred, and who performed it. The sequence of updates can then easily be replayed in order, whenever required, so that the user can relive the entire drawing session.

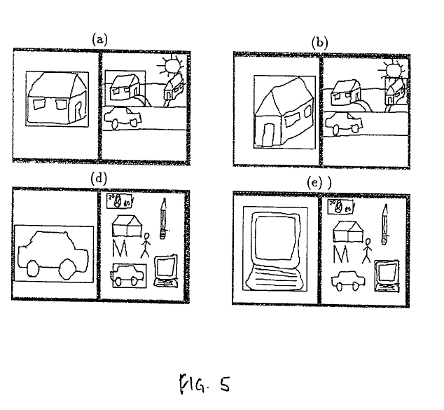

Also contemplated as part of this invention is the ability to retrieve sketches. To do this, it may be necessary to be able to identify and find sub-portions of a sketch quickly. Part of this invention is a shape-recognition algorithm using a variant of “shape context” representation originally described in a paper by [Belongie, et al.], entitled “Shape Context: A New Descriptor for Shape Matching and Object Recognition”, NIPS, November 2000. FIG. 5 shows an example of an object matching algorithm that could be used. In each of the sub-plots, FIGS. 5(a-d), the left portion shows the object to be identified in the right portion.

When capturing the updates to the representation of the paper, it may also be necessary to apply some image enhancement, for example, to improve the resolution of the recovered updates. We intend to utilize our “hallucination” algorithm for super-resolution to accomplish this. This algorithm is described in a first paper by [Baker and Kanada, entitled “Hallucinating Faces”, Proceedings of the Fourth International Conference on Automatic Face and Gesture Recognition, Grenoble, France, March 2000, in a second paper by Baker and Kanade, entitled “Limites on Super Recognition and How to Break Them”, Proceedings of the 2000 IEEE Conference on Computer Vision an Pattern Recognition, Hilton Head, S.C., USA, June 2000.

In an alternative embodiment of the invention, it may be possible to reduce the required bandwidth required for communication between remote sites. By far the largest bandwidth requirement of the system is transmitting the video of the hand drawing. It is possible to reduce the bandwidth requirement if the user is prepared to forfeit the functionality of being able to see the sketch being drawn at the remote site.

The only transmission requirements are then those for synchronization and the propagation of updates to the paper representation.

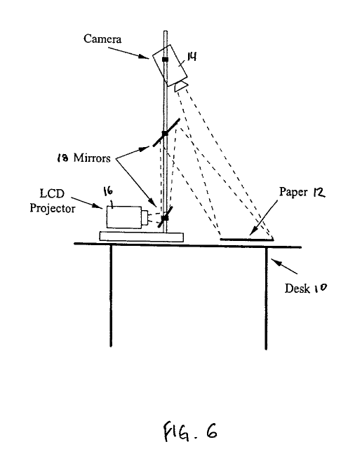

LCD projectors are currently quite expensive, however many business people carry one with them while traveling to give presentations on. Similarly, although not everyone owns an LCD projector in educational environments, most people have access to one which they could borrow for a teleconference with a student. Therefore, in yet another embodiment of the invention, the need for a separate LCD projector is removed by a simple adapter for an LCD projector, which converts it into a site according to the present invention. A design for such an adapter is illustrated in FIG. 6. The device consists of video camera 14 and two planar mirrors 19. Mirrors 19 are arranged in a way that the image from LCD projector 16 is reflected up and then down onto paper 12, as though projector 16 was mounted above desk 12.

Furthermore, instead of the LCD projector, a similar system can be build using a head mount display type of device to superimpose images onto the paper.

The system and algorithms disclosed herein are meant to be exemplary only, and are not intended to limit the scope of the invention, which is set forth in the following claims.

1. A paper-based sketching system comprising:
a projector having a first field-of-view;
a video camera having a second field-of-view, said camera and said projector being arranged such that said first field-of-view and said second field of view substantially overlap, thereby forming a working area; and
a computer, coupled to said projector and said video camera, wherein images captured by said camera from a piece of paper located within said working area are transmitted to one or more remote paper-based sketching systems; and further wherein images received from one or more remote paper-based sketching systems are projected onto said paper by said projector, regardless of the orientation of said paper within said working area.

2. The system of claim 1 wherein said computer can track the orientation of said paper within said working area and can dynamically adjust said projected image such that it is correctly oriented on said paper.

3. The system of claim 1 wherein said computer can detect when a hand is within said working area and further wherein said images are captured and stored after said hand has been removed from said working area.

4. The system of claim 1 further comprising:
a means for connecting said computer to a communications network, such that said captured images may be transmitted in real-time to remote paper-based sketching systems for remote display.

5. The system of claim 4 wherein said real-time transmission happens at a rate of at least approximately 30 frames per second.

6. The system of claim 3 wherein said transmitted images are also stored on said remote paper-based sketching system.

7. The system of claim 3 further comprising a means for tracking said images, such that said images can be replayed in the order in which they were captured.

8. The system of claim 1 further comprising one or more mirrors to assist in the alignment of said first and said second fields-of-view.

9. The system of claim 1 wherein said camera can capture said images regardless of background clutter or the level of ambient light available.

10. A paper-based sketching system comprising:
a video camera having a first field-of-view;
an adapter, for connecting said camera to a projector having a second field of view, such that said first field-of-view and said second field of view substantially overlap, thereby forming a working area; and
a computer, coupled to said projector and said video camera, wherein images captured by said camera from a piece of paper located within said working area are transmitted to one or more remote paper-based sketching systems; and further wherein images received from one or more remote paper-based sketching systems are projected onto said paper by said projector, regardless of the orientation of said paper within said working area.

11. The system of claim 10 wherein said computer can track the orientation of said paper within said working area and can dynamically adjust said projected image such that it is correctly oriented on said paper.

12. The system of claim 10 wherein said computer can detect when a hand is within said working area and further wherein said images are captured and stored after said hand has been removed from said working area.

13. The system of claim 10 further comprising:
a means for connecting said computer to a communications network, such that said captured images may be transmitted to remote paper-based sketching systems for remote display.

14. The system of claim 13 wherein said real-time transmission happens at a rate of at least approximately 30 frames per second.

15. The system of claim 12 wherein said transmitted images are also stored on said remote paper-based sketching system.

16. The system of claim 12 further comprising a means for tracking said images, such that said images can be replayed in the order in which they were captured.

17. The system of claim 10 further comprising one or more mirrors to assist in the alignment of said first and said second fields-of-view.

18. The system of claim 10 wherein said camera can capture said images regardless of background clutter or the level of ambient light available.
